(19) United States
(12) Patent Application Publication
(10) Pub. No.: US 2026/0342468 A1
(43) Pub. Date: Oct. 29, 2026

(54) Progressive WDM Spectrum Loading Maximizing the Best-Case Transmission Condition in a Variable-Spectral-Load Line-System Scenario

(71) Applicant: NEC Laboratories America, Inc., Princeton, NJ (US)

(72) Inventors: Giacomo Borraccini, Plainsboro, NJ (US); Yue-Kai Huang, Princeton, NJ (US); Andrea D'Amico, Plainsboro, NJ (US)

(21) Appl. No.: 19/634,084

(22) Filed: Mar. 31, 2026

Related U.S. Application Data
(60) Provisional application No. 63/794,456, filed on Apr. 25, 2025.

(51) Int. Cl. H04J 14/02; H04B 10/2507

(52) U.S. Cl. CPC H04J 14/02762; H04B 10/2507

(57) ABSTRACT

A method, system, and non-transitory computer-readable medium for managing progressive wavelength-division-multiplexing (WDM) spectrum loading to maximize optimal transmission conditions in a variable-spectral-load optical network. An optical multiplex section (OMS) is evaluated under a full spectral load to establish baseline optical signal-to-noise ratio (OSNR) metrics. A controller initializes a minimal number of WDM channels at a lowest available frequency limit of the spectrum. For all subsequent channel deployment requests, the controller dynamically allocates the new channels starting exclusively from a highest available frequency limit. This progressive loading strategy prevents the population of specific mid-spectrum interference regions (e.g., around channel ID 10) known to induce severe intrinsic response variability in erbium-doped fiber amplifiers (EDFAs), thereby organically minimizing OSNR degradation and reducing required system design margins without relying on computationally expensive simulation algorithms

### CROSS REFERENCE TO RELATED APPLICATIONS

This application claims the benefit of United States Provisional Patent Application Ser. No. 63/794,456 filed Apr. 25, 2025, the entire contents of which is incorporated by reference as if set forth at length herein.

### FIELD OF THE INVENTION

The present disclosure relates generally to optical fiber communications. More particularly, the disclosure relates to methods and systems for spectrum loading in wavelength-division-multiplexing (WDM) networks to minimize signal-to-noise ratio (SNR) design margins under variable spectral loads

### BACKGROUND OF THE INVENTION

In wavelength-division-multiplexing (WDM) fiber-optic networks, spectrum transmission is typically managed using one of two primary strategies: full spectral load and variable spectral loading. In a full spectral load approach, the network operates under stable, fully loaded conditions. This minimizes fluctuations in optical power and system performance, allowing the signal-to-noise ratio (SNR) margin to be precisely defined and managed as a static parameter.

Conversely, the variable spectral loading approach offers simpler infrastructure management by eliminating the need for additional equipment to generate and control dummy-light channels. This flexibility has made variable spectral loading highly popular among network operators. However, variable loading introduces significant complexity in dynamically evaluating the SNR, as performance varies continuously with the current spectral loading due to the intrinsic response variability of erbium-doped fiber amplifiers (EDFAs), particularly dual-stage EDFAs utilized in terrestrial networks. Predicting spectrum variations and minimizing estimated design margins is computationally overwhelming, as the number of possible channel configurations is 2ⁿ, where n represents the number of channels (e.g., 40 channels in a 100-GHz grid within a full C-band scenario).

### SUMMARY OF THE INVENTION

The present invention provides a physical-layer-aware method, system, and non-transitory computer-readable medium for dynamically managing variable spectral loading in a WDM optical network while maintaining optimal transmission conditions.

In a first embodiment, a method for progressive spectrum loading is provided. The method comprises evaluating an optical multiplex section (OMS) under a full spectral load configuration to establish baseline optical signal-to-noise ratio (OSNR) metrics. During live variable spectral loading, the method deploys a defined minimal number of channels at a lowest available frequency. For subsequent connection requests, the method progressively allocates channels starting from the highest available frequency rate. By utilizing this “fixed channels +last fit” approach, the method actively avoids populating regions of the spectrum (such as around channel ID 10) that structurally contribute to the generation of worst-case transmission performance, thereby keeping OSNR design margins minimal.

In a second embodiment, an optical transmission system is provided. The system includes an optical multiplex section (OMS) utilizing dual-stage EDFAs and a software controller configured to execute the progressive loading strategy. The controller leverages the derived distribution variations of OSNR to conservatively populate the spectrum dynamically against a full-load baseline.

In a third embodiment, a non-transitory computer-readable medium stores instructions executable by a processor to configure an automated network routing and wavelength assignment algorithm that allocates initial minimal channels to lower spectrum edges and allocates new channel requests to highest available spectrum frequencies

### BRIEF DESCRIPTION OF THE DRAWING

FIG. 1 is a schematic block diagram of an illustrative experimental setup of an optical multiplex section (OMS) setup implementing variable-spectral-load transmission, according to aspects of the present invention.

FIG. 2(A), FIG. 2(B), FIG. 2(C), FIG. 2(D), and FIG. 2(E) depict graphical representations of illustrative ΔOSNR distributions, including a scatter plot (FIG. 2(A)), and bitmaps (FIG. 2(B), FIG. 2(C), FIG. 2(D), and FIG. 2(E)) for single-amplifier link setups, according to aspects of the present invention.

FIG. 3(A), FIG. 3(B), and FIG. 3(C) illustrate configuration bitmaps comparing average OSNR variation and minimum OSNR variation metrics across different progressive loading strategies including: FIG. 3(A) single EDFA; FIG. 3(B) two-span link, 3 EDFAs; and FIG. 3(C) five-span link, 6 EDFAs according to aspects of the present invention.

FIG. 4 is a flowchart illustrating an algorithmic routine 400 executed by a network controller to implement the progressive spectral loading method.

FIG. 5 is a schematic block diagram illustrating a computer system on which aspects or methods of the present invention may be implemented/executed and/or incorporated into a controller according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

Unless otherwise explicitly specified herein, the FIGs comprising the drawing are not drawn to scale.

### System Architecture

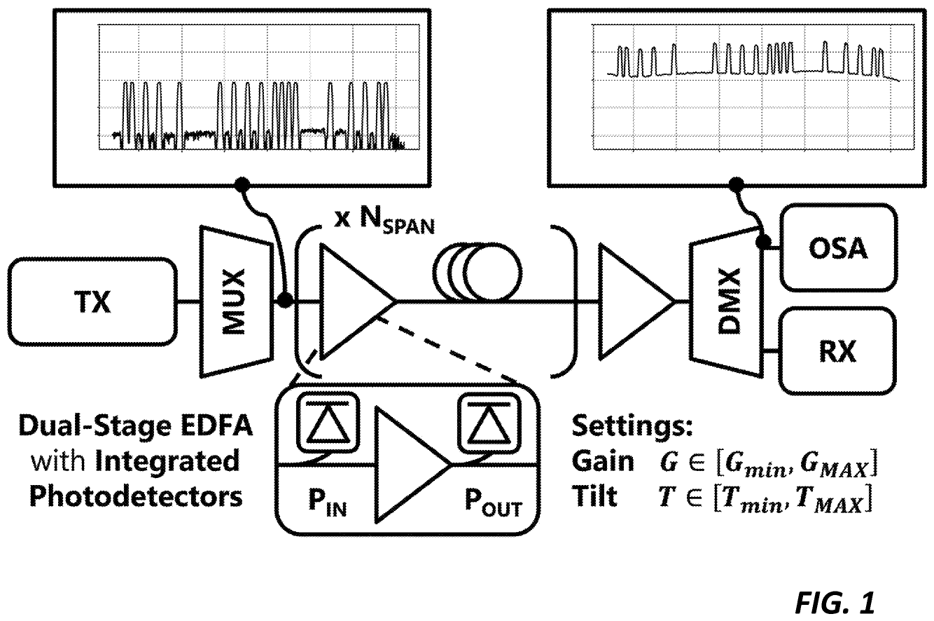

FIG. 1 is a schematic block diagram of an illustrative experimental setup of an optical multiplex section (OMS) setup implementing variable-spectral-load transmission, according to aspects of the present invention.

Referring now to FIG. 1, a transmission scenario is shown comprising an optical multiplex section (OMS) disposed between two reconfigurable optical add & drop multiplexers (ROADMs). The link includes a plurality of spans utilizing standard single-mode optical fiber and dual-stage EDFAs, which may include booster, pre-amplifier, and line amplifiers. An optical spectrum analyzer (OSA) measures the OSNR, which is post-processed to extract signal power and amplified spontaneous emission (ASE) noise for each active channel.

At the transmission node, absolute power for each channel is determined via a ROADM multiplexer (MUX) to maintain a constant power spectral density (PSD). The amplifiers are controlled via automatic gain control (AGC), wherein a target gain (G) and tilt (T) configuration for each amplifier is established during commissioning and maintained during normal network operations. When a new channel is routed, its power is equalized prior to the booster amplifier to preserve the desired PSD.

### Metrics and Baseline Evaluation

To properly evaluate the variable load performance, the system dynamically calculates the OSNR as the logarithmic difference between the signal power and the ASE noise power for each individual channel. All variable configurations are evaluated relative to a full spectral load baseline. The variation metric, ΔOSNR, represents the OSNR difference in decibels (dB) between a specific on-channel configuration and the identical channels in the full-load state. The controller evaluates the arithmetic mean Δ̅O̅S̅N̅R̅ and the minimum value (ΔOSNRₘᵢₙ).

### Progressive Loading Methodology

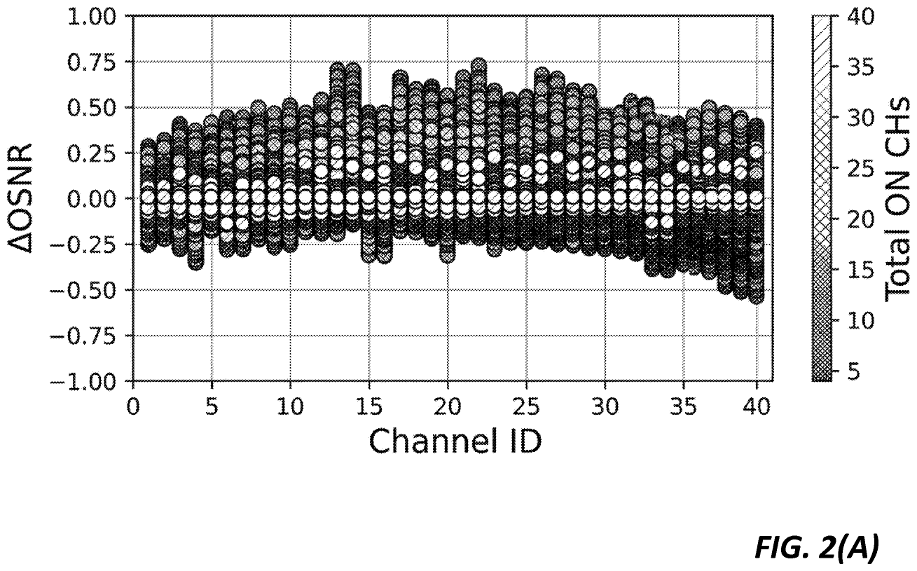

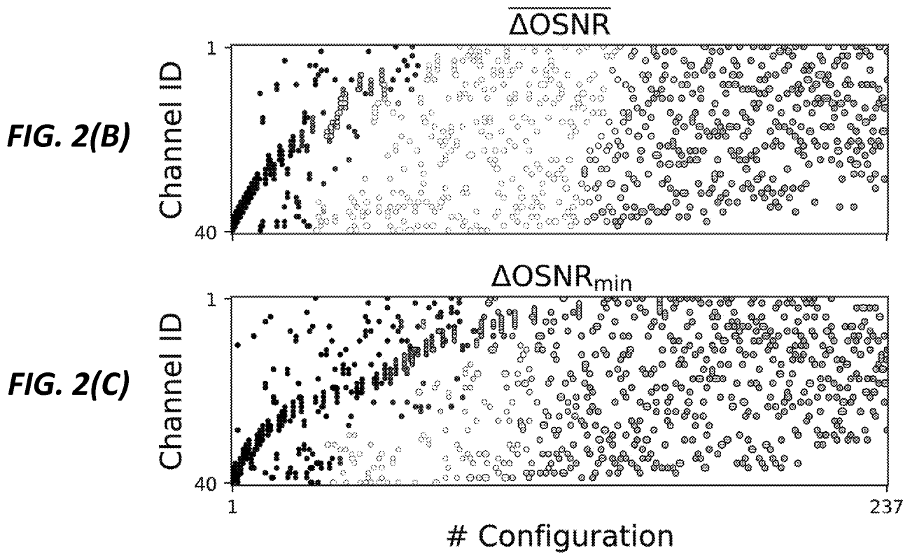

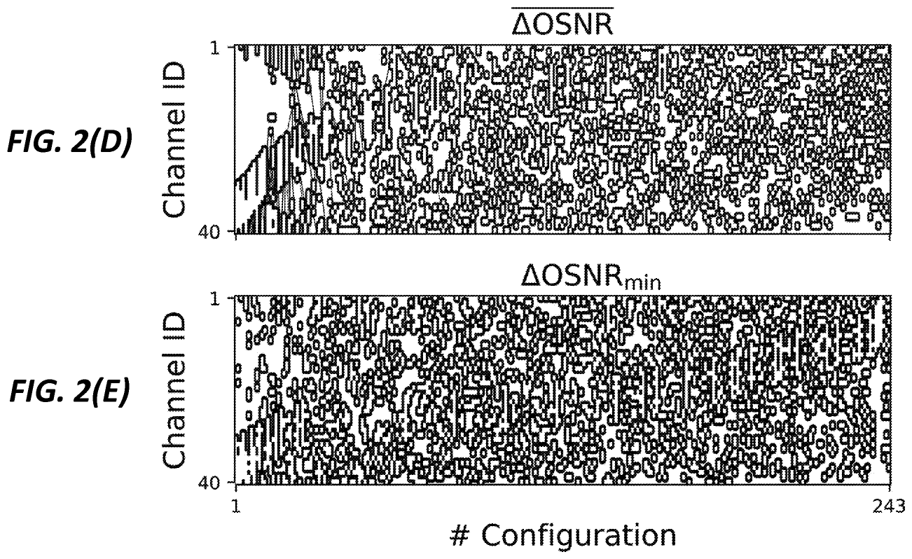

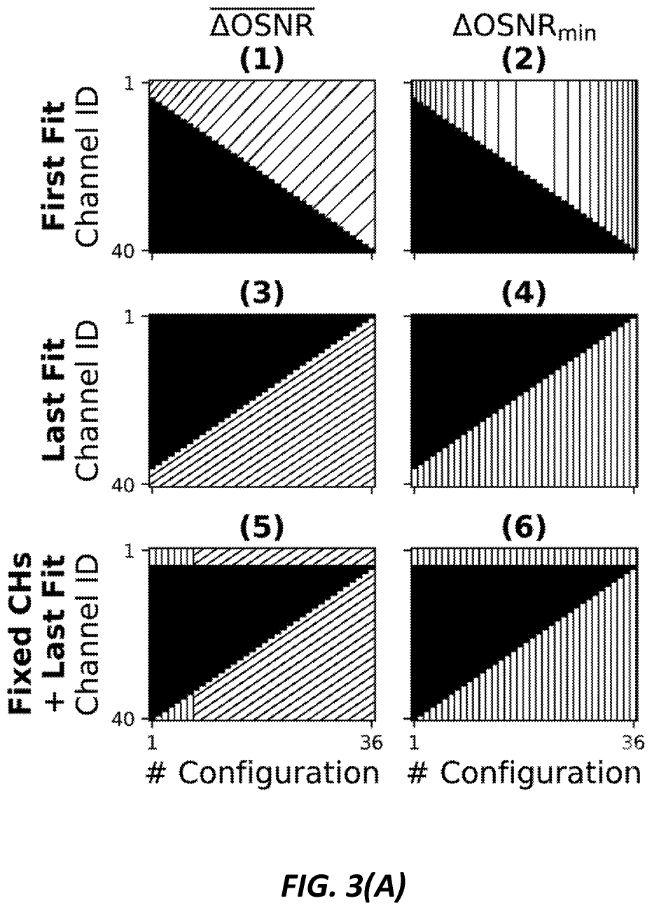

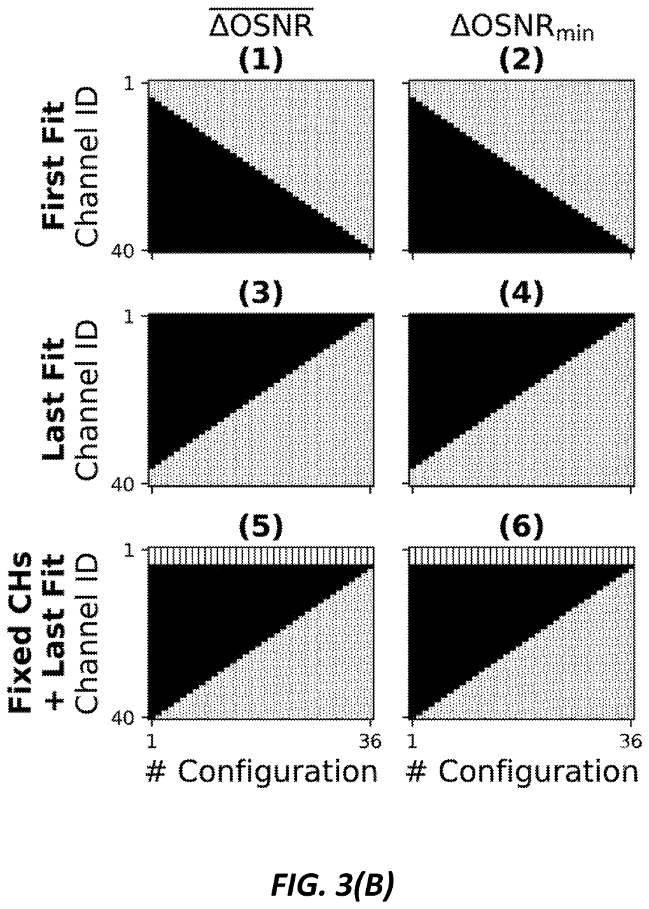

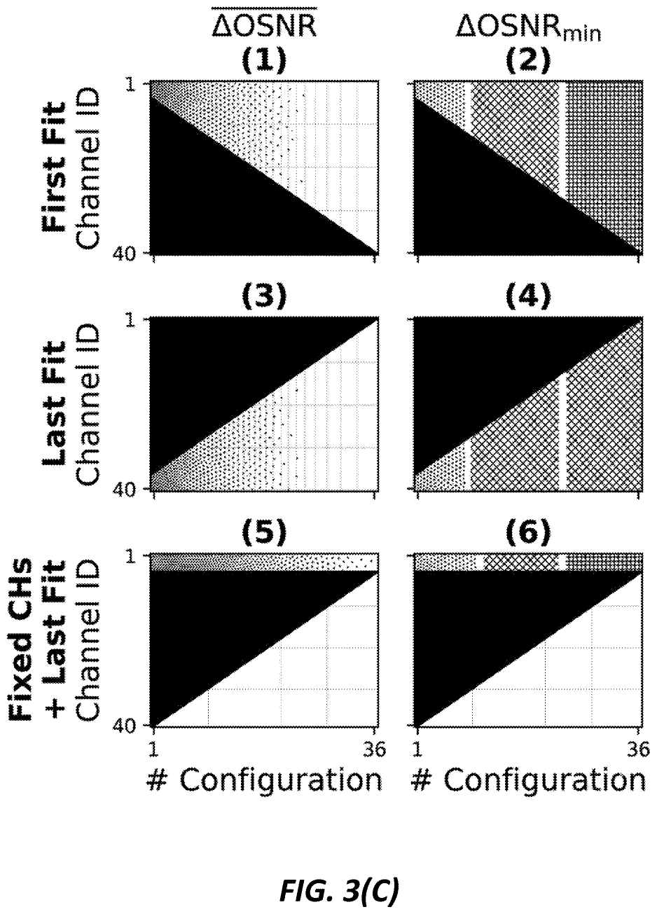

As illustrated by the comparative data shown in FIG. 2(A-E) and FIG. 3(A-C), conventional first-fit (allocating from lowest frequency) and last-fit (allocating from highest frequency) routing assignments often result in substantial OSNR deterioration in multi-span configurations. Specifically, densely populating specific spectral regions, such as the area adjacent to channel ID 10, significantly degrades performance and generates worst-case transmission conditions

To overcome this, the present invention executes a progressive “fixed channels+last fit” routine.

The execution logic comprises:
i. Full Spectrum Evaluation: The transmission line is populated in a full spectral load, amplifiers are tuned to an optimal working point, and the spectrum is captured to define baseline parameters.
ii. Minimal Channel Loading: A minimal threshold of active channels (e.g., four channels) is defined. The system sequentially allocates these initial channels utilizing the lowest available frequencies (first fit edge) until the minimum threshold is met.
iii. Progressive Expansion: Once the minimal threshold is established at the lower spectrum, the system actively switches its allocation parameter to the opposite edge (highest available frequency). As new deployment requests are received, channels are populated progressively downwards from the highest frequency limit, bypassing the central interference zones entirely.

This controlled spectral population organically maintains the OSNR variation adjacent to best-case transmission conditions across multi-span setups without requiring high-overhead computational modeling or data scraping

Below is an overall outline of the progressive spectrum loading method, broken down into its three primary operational phases. This outline clarifies the step-by-step logic used by the system to maintain optimal transmission conditions.

### The Progressive Spectrum Loading Method

### Full Spectrum Evaluation (Establishing the Baseline)

The transmission line is configured in a full spectral load configuration.
The erbium-doped fiber amplifiers (EDFAs) are configured to operate at their optimal working point.
The optical spectrum is captured by an Optical Spectrum Analyzer (OSA) and post-processed to establish the baseline optical signal-to-noise ratio (OSNR) metrics.

### Initializing Minimum Channels (first-fit Anchor)

The system initializes an allocation flag set to the ‘lowest frequency’.
A minimal number of active channels is defined for the initial deployment, such as 4 channels.
The system begins deploying channels by sequentially allocating the lowest frequencies available.
Once the predefined minimal number of channels has been successfully deployed, the system changes the allocation flag to target the ‘highest frequency’.

### Progressive Loading (Last-Fit Expansion)

The system identifies the maximum number of channels available for the spectrum grid.
When a request for a new channel deployment is received, the system allocates the channel to the highest frequency currently available.
The system updates the current number of active channels and continues this top-down allocation for all subsequent requests.
This approach—deploying fixed channels at the bottom and utilizing a last-fit strategy for the rest—intentionally avoids populating the region around channel ID 10, which experimental observations show is the primary contributor to worst-case signal degradation.

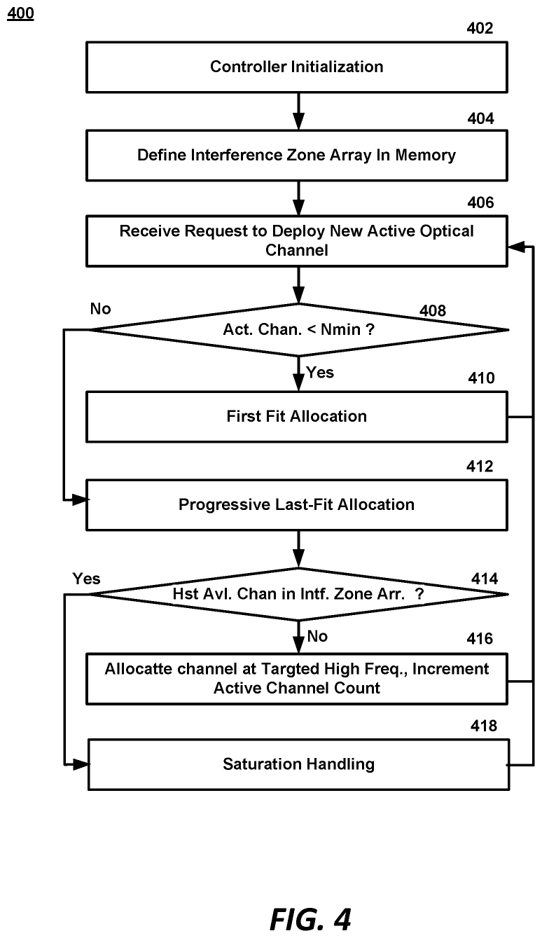

FIG. 4 is a flowchart illustrating an algorithmic routine 400 executed by a network controller to implement the progressive spectral loading method. The controller includes at least one hardware processor and a non-transitory memory storing the algorithmic instructions. The routine begins at block 402, where the controller initializes the system by commanding the optical multiplex section (OMS) to a full spectral load state, optimizing the erbium-doped fiber amplifiers (EDFAs), and recording the baseline optical signal-to-noise ratio (ΔOSNR) array for all available channel IDs (e.g., Channels 1 through 40 in a full C-band grid).

At block 404, the controller defines an interference zone array in memory. Based on historical or baseline data, the interference zone comprises specific channel IDs known to structurally degrade the OSNR when densely populated. In one embodiment, the interference zone array comprises channels at or adjacent to Channel ID 10 (e.g., Channels 8 through 12).

At block 406, the controller receives a request from a network management system (NMS) to deploy a new active optical channel. The algorithm proceeds to a decision block 408 to evaluate the current spectral load against a predefined minimum threshold (Nₘᵢₙ). In one exemplary embodiment, Nₘᵢₙ is set to 4 channels.

If the current count of active channels is less than Nₘᵢₙ (the “Yes” branch of block 408), the algorithm proceeds to block 410. Here, the controller executes a first-fit allocation function, setting a memory pointer to the lowest available frequency limit (e.g., Channel ID 1). The controller allocates the new channel at this lowest available frequency, increments the active channel counter, and returns to block 406 to await the next deployment request.

If the current count of active channels is greater than or equal to Nₘᵢₙ (the “No” branch of block 408), the minimal channel anchor has been successfully established. The algorithm then advances to decision block 412 to execute the progressive last-fit allocation. At block 412, the controller sets the memory pointer to the highest available frequency limit of the WDM spectrum (e.g., Channel ID 40) and scans downward.

Crucially, the algorithm includes an edge-case and saturation handling protocol to prevent catastrophic signal degradation. Before allocating the channel at the highest available frequency, decision block 414 checks if the currently targeted “highest available” channel falls within the predefined interference zone array (e.g., Channels 8-12) defined in block 404.

If the targeted channel is outside the interference zone (the “No” branch of block 414), the algorithm proceeds to block 416, allocates the channel at the targeted high frequency, increments the active channel count, and returns to block 406.

However, if the network is highly saturated and the only available channels reside within the interference zone (the “Yes” branch of block 414), the algorithm triggers a saturation handling subroutine at block 418. Because populating this zone will inherently induce worst-case transmission conditions relative to the full-load baseline, the controller executes one or more compensatory actions prior to allocation.

These actions may include: (i) transmitting an OSNR degradation warning flag to the NMS; (ii) dynamically transmitting control signals to the dual-stage EDFAs to adjust the target gain (G) and tilt (T) parameters away from the commissioning baseline to flatten the localized noise profile; or (iii) commanding the transmitting transponder to increase its forward error correction (FEC) overhead. Following the execution of the compensatory action, the channel is allocated within the interference zone, and the system returns to block 406.

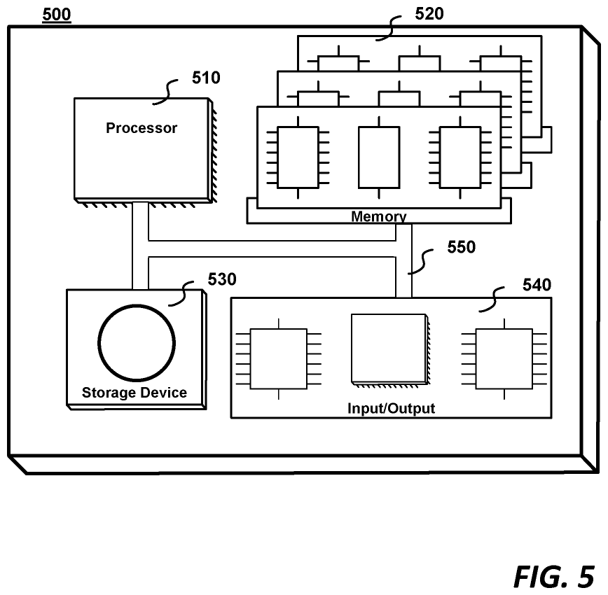

FIG. 5 is a schematic block diagram illustrating a computer system on which aspects or methods of the present invention may be implemented/executed and/or incorporated into a controller according to aspects of the present disclosure.

With reference to that FIG. 5, there it shows an illustrative computer system, 500 suitable for implementing methods and systems according to an aspect of the present disclosure. As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 500 as stored program control instructions.

Computer system 500 includes processor 510, memory 520, storage device 530, and input/output structure 540. One or more input/output devices may include a display. One or more busses 550 typically interconnect the components, 510, 520, 530, and 540. Processor 510 may be a single or multi core. Additionally, the system may include accelerators etc further comprising the system on a chip.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations for system 500.

We have described a variable spectral loading scenario in an OMS, pointing out performance features related to the worst and best cases of transmission conditions. We have shown a rule to populate the spectrum maintaining the OSNR variation induced by the EDFAs close to the best case. Repeating the analysis after modifying the target parameter settings for the single-amplifier case or the booster gain for the OMS setups—moving the OMS working point from the optimal one—provides consistent results with the shown analysis.

At this point, those skilled in the art will understand that while we have presented our inventive concepts and description using specific examples, our invention is not so limited. Accordingly, the scope of our invention should be considered in view of the following claims.

1. A method for dynamically managing variable spectrum loading in an optical fiber transmission network, the method comprising:
configuring an optical multiplex section (OMS) in a full spectral load configuration;
evaluating the full spectral load configuration to establish a baseline optical signal-to-noise ratio (OSNR) performance metric;
allocating a predefined minimal number of active channels to a lowest available frequency edge within a wavelength-division-multiplexing (WDM) spectrum;
receiving a request for a subsequent active channel deployment in the WDM spectrum; and
dynamically allocating the subsequent active channel to a highest available frequency edge within the WDM spectrum to optimize transmission performance relative to the baseline OSNR performance metric.

2. The method of claim 1, further comprising capturing the WDM spectrum via an optical spectrum analyzer (OSA) and extracting a signal power and an amplified spontaneous emission (ASE) noise for each active channel.

3. The method of claim 2, further comprising computing a ΔOSNR parameter representing a logarithmic difference in decibels between a current variable-load on-channel configuration and corresponding channels within the full spectral load configuration.

4. The method of claim 3, wherein the subsequent active channel is allocated such that a minimum ΔOSNR value (ΔOSNRₘᵢₙ) is maintained at or above a predetermined threshold.

5. The method of claim 1, wherein dynamically allocating the subsequent active channel to the highest available frequency edge inherently prevents allocation of active channels within an interference region located at or adjacent to a channel ID 10 of a C-band spectrum.

6. The method of claim 1, further comprising maintaining a constant power spectral density (PSD) across the WDM spectrum by determining an absolute power of each active channel via a reconfigurable optical add & drop multiplexer (ROADM).

7. The method of claim 1, wherein the OMS comprises a plurality of dual-stage erbium-doped fiber amplifiers (EDFAs) operating in an automatic gain control (AGC) configuration.

8. An optical transmission system configured to maximize best-case transmission conditions during variable spectral loading, the system comprising:
an optical multiplex section (OMS) comprising a plurality of optical fiber spans and a plurality of optical amplifiers;
a multiplexer configured to add optical channels into a wavelength-division-multiplexing (WDM) spectrum; and
a controller communicatively coupled to the multiplexer, the controller comprising a processor and a memory storing instructions that, when executed, cause the system to:
evaluate a full spectral load of the OMS to record a baseline transmission metric;
route a threshold minimum number of optical channels using a first-fit strategy anchored at a lowest available frequency limit of the WDM spectrum; and
route all subsequent optical channels using a last-fit strategy anchored at a highest available frequency limit of the WDM spectrum to avoid a region of amplifier response variability.

9. The optical transmission system of claim 8, wherein the baseline transmission metric is a signal-to-noise ratio (SNR) design margin.

10. The optical transmission system of claim 8, further comprising an optical spectrum analyzer (OSA) coupled to a demultiplexer at a receiving node of the OMS, the OSA configured to isolate amplified spontaneous emission (ASE) noise.

11. The optical transmission system of claim 8, wherein the region of amplifier response variability is a spectrum band centrally located within a C-band grid that structurally generates a maximum negative optical signal-to-noise ratio variation.

12. The optical transmission system of claim 8, wherein the threshold minimum number of optical channels comprises at least four active channels.

13. The optical transmission system of claim 8, wherein the plurality of optical amplifiers comprises erbium-doped fiber amplifiers (EDFAs) configured with fixed gain and tilt settings established during a commissioning phase.

14. The optical transmission system of claim 8, wherein the controller actively refrains from applying the last-fit strategy until a current count of active channels allocated via the first-fit strategy equals the threshold minimum number.

15. A non-transitory computer-readable medium storing executable instructions for controlling a routing wavelength assignment algorithm in an optical communications network, the instructions, when executed by a hardware processor, causing the processor to perform operations comprising:
receiving data representing an optimal working point of a plurality of amplifiers under a full spectral WDM load;
initializing an allocation flag to target a lowest frequency of a variable spectral load transmission band;
deploying a minimal channel count of optical signals to the targeted lowest frequency;
verifying the minimal channel count has been successfully deployed;
switching the allocation flag to target a highest frequency of the variable spectral load transmission band; and
progressively loading new optical signals downward from the targeted highest frequency to minimize estimated signal-to-noise ratio (SNR) design margins.

16. The non-transitory computer-readable medium of claim 15, wherein the operations further comprise calculating an arithmetic mean variation Δ̅O̅S̅N̅R̅ for the progressively loaded new optical signals relative to the full spectral WDM load.

17. The non-transitory computer-readable medium of claim 15, wherein deploying the minimal channel count to the targeted lowest frequency prevents worst-case signal degradation induced by dual-stage erbium-doped fiber amplifiers.

18. The non-transitory computer-readable medium of claim 15, wherein progressively loading new optical signals downward limits channel densities in a middle-lower region of the variable spectral load transmission band.

19. The non-transitory computer-readable medium of claim 15, wherein the variable spectral load transmission band comprises up to 40 channels configured within a 100-GHz spaced grid.

20. The non-transitory computer-readable medium of claim 15, wherein the instructions are executed by a machine-learning software controller configured to predict spectrum variations over a multi-span optical multiplex section (OMS).
